(19) United States
(12) Patent Application Publication
(10) Pub. No.: US 2007/0070015 A1
(43) Pub. Date: Mar. 29, 2007

(54) Liquid crystal display and driving method thereof

(75) Inventors: Hak-Sun Chang, Yongin-si (KR); Yoon-Sung Um, Yongin-si (KR); Seung-Hoo Yoo, Seongnam-si (KR); Hyun-Wuk Kim, Yongin-si (KR); Hee-Wook Do, Suwon-si (KR); Kang-Woo Kim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd

(21) Appl. No.: 11/508,496

(22) Filed: Aug. 23, 2006

(30) Foreign Application Priority Data
Sep. 28, 2005 (KR) 10-2005-0090493

(51) Int. Cl. G09G 3/36

(52) U.S. Cl. 345/94

(57) ABSTRACT

A liquid crystal display including a plurality of pixels having a plurality of sub-areas, an image signal modifier for generating a preliminary signal based on a previous image signal and a current image signal and generating a modified image signal based on the preliminary signal and a next image signal, and a data driver for changing the modified image signal from the image signal modifier into a data voltage and supplying it to the pixels. A minimum target pixel voltage of difference voltages between the data voltage and the common voltage is larger than a minimum pixel voltage.

### CROSS-REFERENCE TO RELATED PATENT APPLICATION

This application claims priority to Korean Patent Application No. 2005-0090493, filed in the Korean Intellectual Property Office, on Sep. 28, 2005, the disclosure of which is incorporated by reference herein.

### BACKGROUND OF THE INVENTION

(a) Technical Field

The present disclosure relates to a liquid crystal display and a driving method thereof.

(b) Discussion of the Related Art

Liquid crystal displays (LCDs) include a pair of panels provided with field generating electrodes and a liquid crystal (LC) layer having a dielectric anisotropy, which is disposed between the two panels. The field generating electrodes generally include a plurality of pixel electrodes arranged in a matrix and a common electrode. The pixel electrodes are connected to switching elements such as thin film transistors (TFTs) and are supplied with data voltages along every row of the matrix. The common electrode covers the entire surface of a panel and is supplied with a common voltage. A pair of field generating electrodes that generate an electric field and a liquid crystal disposed therebetween form a structure known in the art as a liquid crystal capacitor that is a basic element of a pixel.

Voltages are applied to the field generating electrodes to generate an electric field within the liquid crystal layer. The strength of the electric field can be controlled by adjusting the voltage across the liquid crystal capacitor. Since the electric field determines the orientations of liquid crystal molecules and these molecular orientations determine the transmittance of light passing through the liquid crystal layer, the light transmittance is adjusted by controlling the applied voltages, thereby obtaining desired images.

A polarity of data voltages with respect to a common voltage is toggled every frame, every row, or every pixel to prevent image deterioration due to long-time application of a unidirectional electric field.

Since LCDs are being increasingly used for displaying motion images, there is a need to improve the slow response time of liquid crystals. In particular, an increase in the size and resolution of display devices requires a significant improvement in response time.

### SUMMARY OF THE INVENTION

In an exemplary embodiment of the present invention, a liquid crystal device includes a plurality of pixels having a plurality of sub-areas, an image signal modifier for generating a preliminary signal based on a previous image signal and a current image signal and generating a modified image signal based on the preliminary signal and a next image signal, and a data driver for changing the modified image signal from the image signal modifier into a data voltage and supplying it to the pixels, wherein a minimum target pixel voltage of difference voltages between the data voltage and a common voltage is larger than a minimum pixel voltage.

In an exemplary embodiment of the present invention, a liquid crystal display includes a pixel electrode having a first electrode portion including a first pair of oblique edges parallel to and facing each other and a second electrode portion including a second pair of oblique edges parallel to and facing each other, respectively, a common electrode facing the pixel electrode, a liquid crystal layer interposed between the pixel electrode and the common electrode, a first tilt direction defining member formed on the second electrode portion, having a first cutout including a first oblique portion substantially parallel to the second pair of oblique edges, for defining a tilt direction of liquid crystal molecules of the liquid crystal, and a second tilt direction defining member formed on the common electrode, having a second cutout including a second oblique portion substantially parallel to the second pair of oblique edges, for defining a tilt direction of liquid crystal molecules of the liquid crystal, wherein a black voltage applied between the pixel electrode and the common electrode is 1.5V-2.0V.

In an exemplary embodiment of the present invention, a driving method of a liquid crystal display having a plurality of pixels is provided, which includes reading a previous image signal, a current image signal, and a next image signal, generating a preliminary signal based on the previous image signal and the current image signal, generating a modified image signal based on the preliminary signal and the next image signal, and applying a pixel voltage corresponding to the modified image signal to the pixels, wherein a minimum target pixel voltage corresponding to a black gray is larger than a minimum pixel voltage.

### BRIEF DESCRIPTION OF THE DRAWINGS

The present invention will become more apparent by describing in detail exemplary embodiments thereof with reference to the attached drawings, in which:

FIG. 1 is a block diagram of an LCD according to an exemplary embodiment of the present invention;

FIG. 2 is an equivalent circuit diagram of a pixel of an LCD according to an exemplary embodiment of the present invention;

FIGS. 3A to 3C illustrate pieces of a pixel electrode of an LCD according to an exemplary embodiment of the present invention, respectively;

FIG. 4 illustrates a pixel electrode and a common electrode of a liquid crystal panel assembly according to an exemplary embodiment of the present invention;

FIG. 5 illustrates a TFT array panel for an LCD according to an exemplary embodiment of the present invention;

FIG. 6 illustrates a common electrode panel for an LCD according to an exemplary embodiment of the present invention;

FIG. 7 illustrates an LCD including the TFT array panel shown in FIG. 5 and the common electrode panel shown in FIG. 6;

FIG. 8 illustrates the LCD shown in FIG. 7 taken along lines VIII-VIII;

FIG. 9 illustrates an image signal modifier of an LCD according to an exemplary embodiment of the present invention;

FIG. 10 is a flow chart illustrating the operations of the image signal modifier shown in FIG. 9;

FIG. 11 is a schematic diagram that explains an image signal modifying method according to an exemplary embodiment of the present invention;

FIGS. 12A and 12B are waveform diagrams illustrating modified signals according to an exemplary embodiment of the present invention, respectively;

FIG. 13 is a graph illustrating response time with respect to electrode intervals and a pre-tilt voltage in an LCD according to an exemplary embodiment of the present invention;

FIG. 14 is a graph illustrating response time with respect to a black voltage and a pre-tilt voltage in an LCD according to an exemplary embodiment of the present invention;

FIG. 15 is a graph illustrating contrast ratio with respect to electrode intervals and a pre-tilt voltage in an LCD according to an exemplary embodiment of the present invention; and

FIG. 16 is a graph illustrating response time with respect to a black voltage in an LCD according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings.

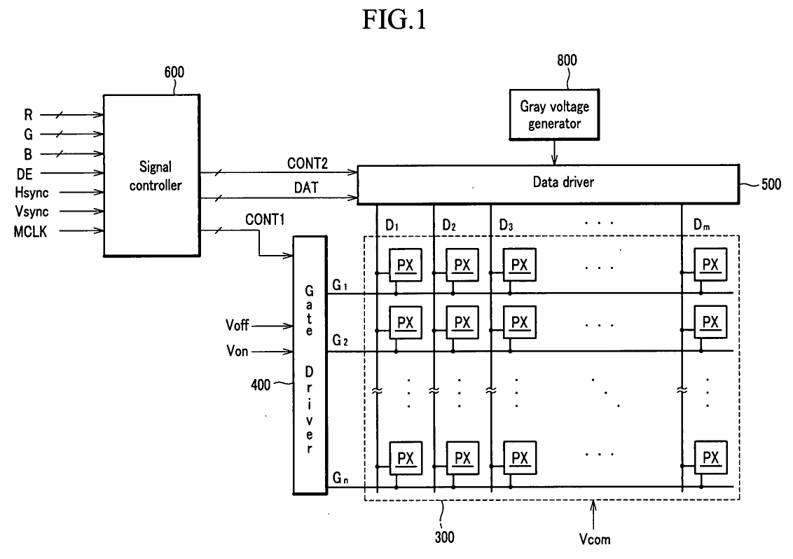

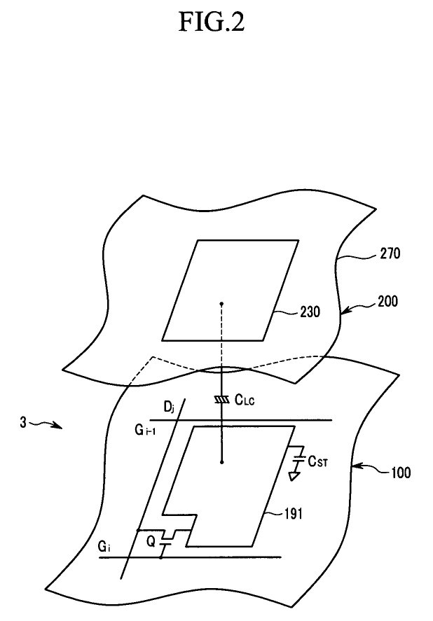

FIG. 1 is a block diagram of an LCD according to an exemplary embodiment of the present invention, and FIG. 2 is an equivalent circuit diagram of a pixel of an LCD according to an exemplary embodiment of the present invention.

Referring to FIG. 1, an LCD according to an embodiment of the present invention includes an LC panel assembly 300, a gate driver 400, a data driver 500, a gray voltage generator 800, and a signal controller 600. The gate driver 400 and data driver 500 are electrically connected to the LC panel assembly 300. The gray voltage generator is electrically connected to the data driver 500. The signal controller 600 is electrically connected to the gate driver 400 and the data driver 500 and controls the LC panel assembly 300.

The LC panel assembly 300, illustrated in FIG. 2, includes a thin film transistor array panel 100, a common electrode panel 200, and a liquid crystal layer 3 interposed therebetween. Referring to FIG. 1, the LC panel assembly further includes a plurality of signal lines G₁-G_{N} and D₁-Dₘ and a plurality of pixels PX connected thereto and arranged substantially in a matrix.

The signal lines G₁-Gₙ and D₁-Dₘ are provided on the thin film transistor array panel 100 and include a plurality of gate lines G₁-Gₙ for transmitting gate signals (called scanning signals) and a plurality of data lines D₁-Dₘ for transmitting data signals. The gate lines G₁-Gₙ extend substantially in a row direction and are substantially parallel to each other, while the data lines D₁-Dₘ extend substantially in a column direction and are substantially parallel to each other.

Referring to FIG. 2, each pixel PX, for example, a pixel PX in the i-th row (i=1, 2, . . . , n) and the j-th column (j=1, 2, . . . , m), is connected to signal lines G₁ and Dⱼ and includes a switching element Q connected to the signal lines G₁-G_{N} and D₁-Dₘ. An LC capacitor C_{LC} and a storage capacitor C_{ST} are connected to the switching element Q. The storage capacitor C_{ST} is optional.

The switching element Q is provided on the transistor array panel 100 and may be a TFT with three terminals including a control terminal connected to one of the gate lines G₁-Gₙ, an input terminal connected to one of the data lines D₁-Dₘ, and an output terminal connected to the LC capacitor C_{LC} and the storage capacitor C_{ST}.

The LC capacitor C_{LC} includes a pixel electrode 191 provided on the thin film transistor array panel 100 and a common electrode 270 provided on the common electrode panel 200, as two terminals. The LC layer 3 is disposed between the two electrodes 191 and 270, and functions as a dielectric of the LC capacitor C_{LC}. The pixel electrode 191 is connected to the switching element Q, and the common electrode 270 is supplied with a common voltage Vcom and covers an entire surface of the common electrode panel 200. Although not illustrated in FIG. 2, the common electrode 270 may be provided on the thin film transistor array panel 100, and both electrodes 191 and 270 may be shaped as bars or stripes.

The storage capacitor C_{ST} is an auxiliary capacitor for the LC capacitor C_{LC}. The storage capacitor C_{ST} includes the pixel electrode 191 and a separate signal line (not shown), which is provided on the thin film transistor array panel 100, overlaps the pixel electrode 191 via an insulator, and is supplied with a predetermined voltage such as the common voltage Vcom. Alternatively, the storage capacitor C_{ST} includes the pixel electrode 191 and an adjacent gate line called a previous gate line, which overlaps the pixel electrode 191 via an insulator.

For color display, each pixel PX uniquely represents one primary color (i.e., spatial division) or each pixel PX sequentially represents each of the primary colors in turn (i.e., temporal division) such that a spatial or temporal sum of the primary colors produces a desired color. The primary colors include red, green, and blue. FIG. 2 shows an example of spatial division in which each pixel PX includes a color filter 230 representing one of the primary colors in an area of the common electrode panel 200 facing the pixel electrode 191. Alternatively, the color filter 230 may be provided on or under the pixel electrode 191 on the thin film transistor array panel 100. In addition, one or more polarizers (not shown) are attached to at least one of the panels 100 and 200.

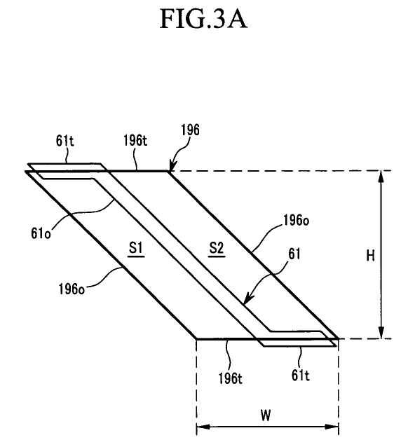

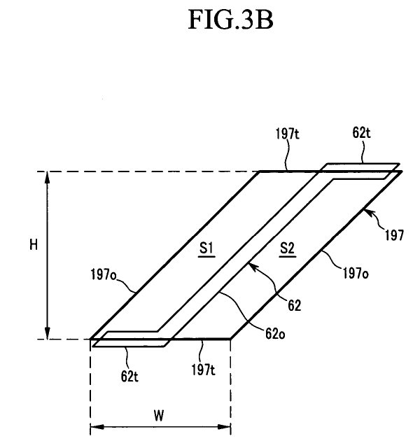

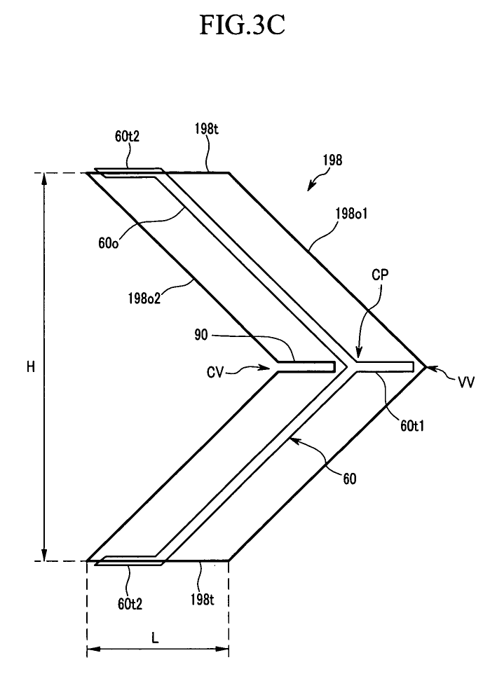

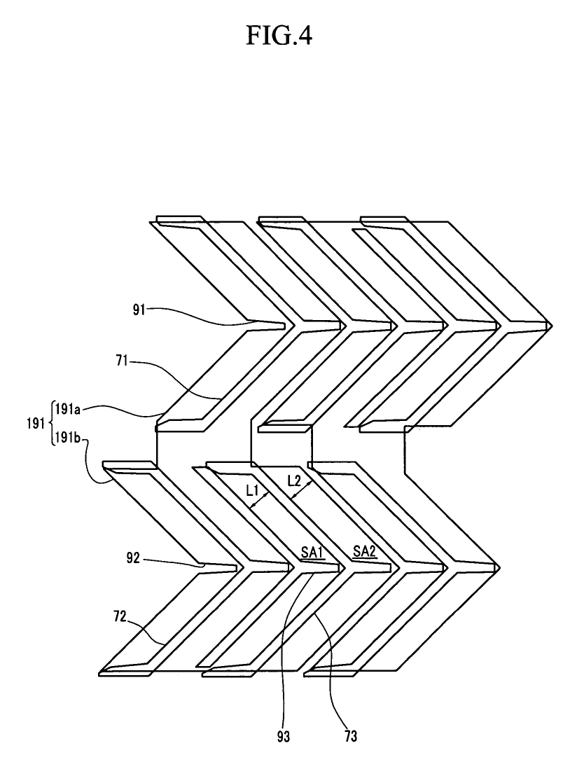

Structures of the pixel electrode and the common electrode of the LCD will be described in detail with reference to FIGS. 3A to 4.

FIGS. 3A to 3C illustrate pieces of a pixel electrode of an LCD according to an exemplary embodiment of the present invention, respectively, and FIG. 4 illustrates a pixel electrode and a common electrode of a liquid crystal panel assembly according to an exemplary embodiment of the present invention.

Each of the pixel electrodes 191 includes at least one electrode piece of a parallelogram shown in FIG. 3A and an electrode piece of a parallelogram shown in FIG. 3B.

The electrode pieces 196 and 197 shown in FIGS. 3A and 3B are vertically connected to form a base electrode 198 shown in FIG. 3C, which is a basic structure of each of the pixel electrodes 191.

As shown in FIGS. 3A and 3B, each of the electrode pieces 196 and 197 has a shape of a parallelogram having a pair of oblique edges 196o and 197o and a pair of transverse edges 196t and 197t. Each of the oblique edges 196o and 197o makes an oblique angle with the transverse edges 196t and 197t, and the oblique angle ranges from about 45 degrees to about 135 degrees. For descriptive convenience, the electrode pieces 196 and 197 are classified into two types based on an inclination direction relative to a normal at the bottom of the pair of transverse edges 196t and 197t. The electrode piece 196 shown in FIG. 3A is referred to as “right-inclined” since it is inclined to the right, while the electrode piece 197 shown in FIG. 3B is referred to as “left-inclined” since it is inclined to the left.

The width W of the electrode pieces 196 and 197, which is defined as the length of the transverse edges 196t and 197t, and the height H, which is defined as the distance between the transverse edges 196t and 197t, may be determined based on the size of the LC panel assembly 300. The electrode pieces 196 and 197 may be embodied as parallelogram shapes other than those illustrated in FIGS. 3a and 3b.

The common electrode 270 has cutouts 61 and 62 facing the electrode pieces 196 and 197, and each of the electrode pieces 196 and 197 are partitioned into two sub-areas S1 and S2 by the cutouts 61 and 62. Each of the cutouts 61 and 62 includes an oblique portion 610 and 620 substantially parallel to the oblique edges 196o and 197o of the electrode pieces 196 and 197 and a pair of transverse portions 61t and 62t, which make an obtuse angle with the oblique portion 610 and 620 and overlap the transverse edges 196t and 197t of the electrode pieces 196 and 197.

Each of the sub-areas S1 and S2 has a pair of primary edges defined by the oblique portion 610 and 620 of the cutouts 61 and 62 and the oblique edges 196t and 197t of the electrode pieces 196 and 197. The distance between the primary edges, i.e., the width of the sub-areas S1 and S2, may be equal to or greater than about 25 microns, and the widths may be different.

The base electrode 198 shown in FIG. 3C is formed by vertically combining the right-inclined electrode piece 196 and the left-inclined electrode piece 197. The angle made by the right-inclined electrode piece 196 and the left-inclined electrode piece 197 may be about a right angle, and the connection between the electrode pieces 196 and 197 may be made only at some portions. The edge portions of the electrode pieces 196 and 197, which are not connected to each other, form a cutout 90 disposed at a concavity. However, when the connection is made at all portions of the electrode pieces 196 and 197, the cutout 90 may not be present.

The outer transverse edges 196t and 197t of the electrode pieces 196 and 197 form transverse edges 198t of the base electrode 198, and corresponding oblique edges 196o and 197o of the electrode pieces 196 and 197 are connected to each other to form curved edges 198o1 and 198o2 of the base electrode 198.

The curved edges 198o1 and 198o2 include a convex edge 198o1 meeting the transverse edges 198t at an obtuse angle, for example, about 135 degrees, and a concave edge 198o2 meeting the transverse edges 198t at an acute angle, for example, about 45 degrees. The curved edges 198o1 and 198o2, which are formed by a meeting of the oblique edges 196o and 197o, have a curved angle of about a right angle.

The cutout 60 extends from a concave vertex CV on the concave edge 198o2 toward a convex vertex W of the convex edge 198o1 and is disposed near a center of the base electrode 198.

The cutouts 61 and 62 of the common electrode 270 are connected to each other to form a cutout 60. The transverse portions 61t and 62t of the cutouts 61 and 62, which overlap each other, are put together to form a transverse portion 60t1.

The cutout 60 includes a curved portion 600 having a curved point CP, a center transverse portion 60t1 connected to the curved point CP of the curved portion 600, and a pair of terminal transverse portions 60t2 connected to ends of the curved portion 60o. The curved portion 60o of the cutout 60 includes a pair of oblique portions meeting at about a right angle, extending substantially parallel to the curved edges 198o1 and 198o2 of the base electrode 198, and bisecting the base electrode 198 into left and right halves. The center transverse portion 60t1 of the cutout 60 makes an obtuse angle, for example, about 135 degrees with the curved portion 60o, and extends toward the convex vertex VV of the base electrode 198. The terminal transverse portions 60t2 are aligned with the transverse edges 198t of the base electrode 198 and make an obtuse angle, for example, about 135 degrees with the curved portion 60o.

The base electrode 198 and the cutout 60 have inversion symmetry with respect to an imaginary straight line (referred to as a center transverse line) connecting the convex vertex W and the concave vertex CV of the base electrode 198.

FIG. 4 illustrates a pixel electrode and a common electrode of a liquid crystal panel assembly according to an exemplary embodiment of the present invention. Referring to FIG. 4, each of the pixel electrodes 191 includes a pair of first and second electrode portions 191a and 191b, and a connection attaching the two electrode portions 191a and 191b. The first and second electrode portions 191a and 191b are connected to each other in a row direction and include cutouts 91-93. The number of electrode pieces of the second electrode portion 191b is larger than that of the first electrode portion 191a. The common electrode 270 includes cutouts 71-73 facing the first and second electrode portions 191a and 191b.

The first electrode portion 191a includes a combination of two right-inclined electrode pieces and two left-inclined electrode pieces, and has a structure substantially equal to a structure in which a pair of the base electrodes 198 are connected in the row direction.

The arrangements of the electrode portions 191a and 191b and the cutouts 71-73 and 91-93 shown in FIG. 4 are obtained by repeating the arrangement of the base electrode 198 and the cutouts 60 and 90 in the row and column directions.

The second electrode portion 191b has a shape where two base electrodes 198 are connected at upper and lower ends thereof so that the concave edge of one of the two base electrodes 198 may neighbor the convex edge of the other of the two base electrodes 198. A gap between the two base electrodes 198 and a cutout 90 meeting the gap form a new cutout 93.

The cutout 93 includes a curved portion bisecting the second electrode portion 191b into left and right halves, and a transverse portion meeting the curved portion.

Referring to FIG. 3C, the length L of a transverse edge 198t of the base electrode 198 is defined as the length of the base electrode 198, and the distance H between the two transverse edges 198t of the base electrode 198 is defined as the height of the base electrode 198. In FIG. 4, the height of the first electrode portion 191a is substantially equal to the height of the second electrode portion 191b, and the length of the second electrode portion 191b is about 2 times or less the length of the first electrode portion 191a. Accordingly, the area of the second electrode portion 191b is 2 times or less the area of the first electrode portion 191a.

As shown in FIG. 4, the first electrode portion 191b and the second electrode portion 191b are alternately arranged in the row and column directions.

Regarding the arrangement of the electrode portions 191a and 191b in the row direction, the center transverse line of the first electrode portion 191a coincides with the second electrode portion 191b. The convex edge of the first electrode portion 191a neighbors the concave edge of the second electrode portion 191b, and the concave edge of the first electrode portion 191a neighbors the convex edge of the second electrode portion 191b.

Regarding the arrangement in the column direction, since the lengths of the first and second electrode portions 191a and 191b are different, several arrangements may be considered. One exemplary arrangement is to deviate the curved edges of one of the two electrode portions 191a and 191b from the curved edges of the other of the two electrode portions 191a and 191b. In an example shown in FIG. 4, the first electrode portion 191a is aligned with a center of the second electrode portion 191b. The example shown in FIG. 4 connects the curved portion of the cutout 71 bisecting the first electrode portion 191a to the curved portion of the cutout 93 bisecting the second electrode portion 191b. Therefore, the concave edge and the convex edge of the first electrode portion 191a are connected to the curved portions of the cutouts 72 and 73 bisecting the base electrodes of the second electrode portion 191b. Alternatively, the first electrode portion 191a may be disposed to on one of the base electrodes of the second electrode portion 191b.

Sub-areas of the second electrode portion 191b have different sizes and areas. Two inner sub-areas SA1 among four sub-areas arranged in the row direction have a width L1 that is smaller than a width L2 of two outer sub-areas SA2. The width L1 of the inner sub-areas SA1 may be equal to about 20-30 microns, while the width L2 of the inner sub-areas SA2 may be equal to about 30-40 microns.

The first and second electrode portions 191a and 191b are arranged in the row or column direction for balance have an area ratio of about 1:2, and are well organized with less empty space to increase the aperture ratio.

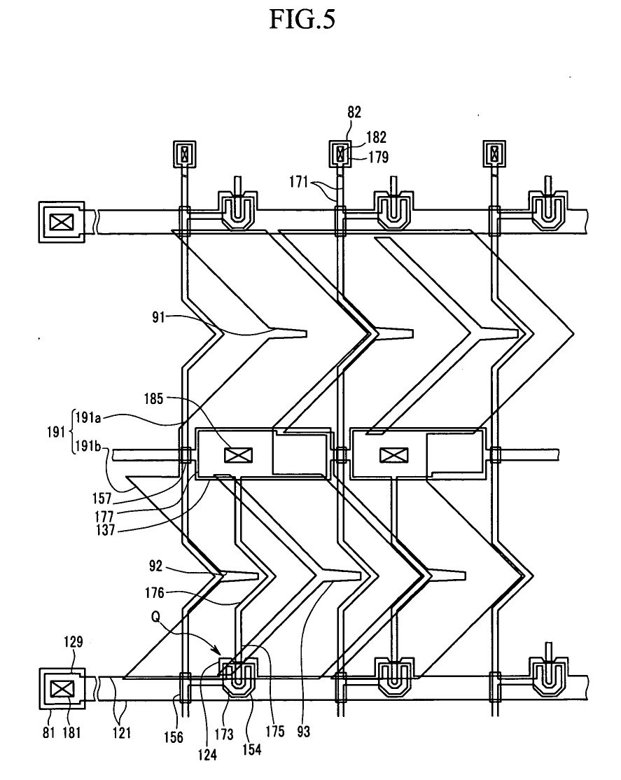

A liquid crystal panel assembly according to an exemplary embodiment of the present invention will be described in detail with reference to FIGS. 5 to 8.

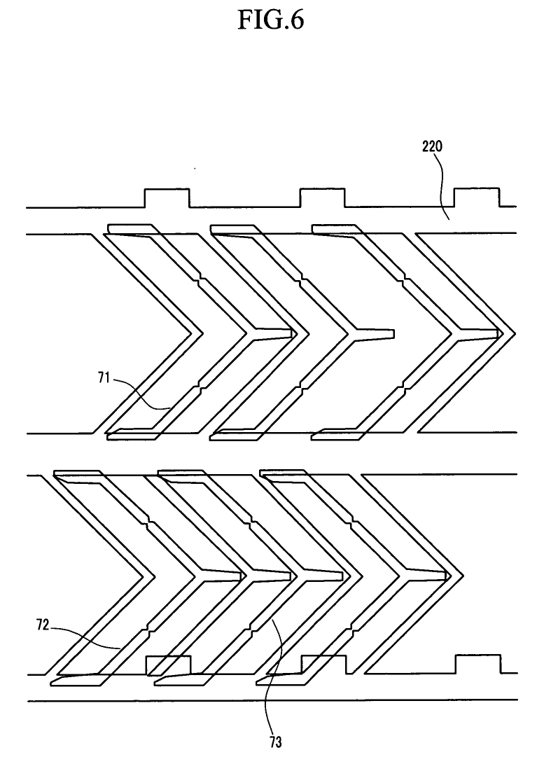

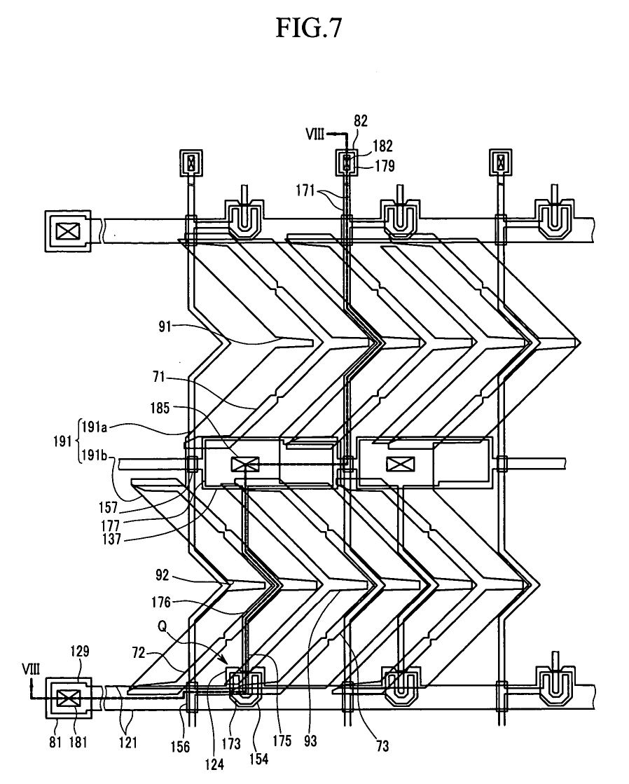

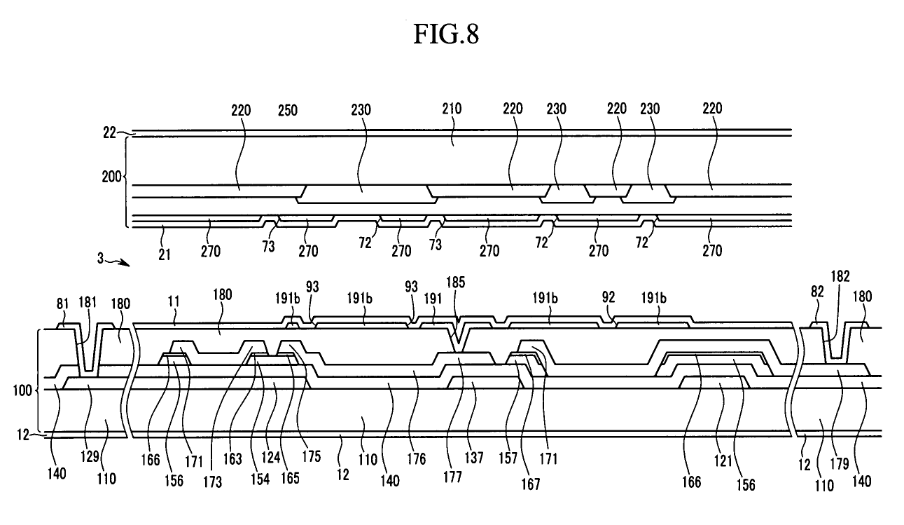

FIG. 5 illustrates a TFT array panel for an LCD according to an exemplary embodiment of the present invention, FIG. 6 illustrates a common electrode panel for an LCD according to an exemplary embodiment of the present invention, and FIG. 7 illustrates an LCD including the TFT array panel shown in FIG. 5 and the common electrode panel shown in FIG. 6. FIG. 8 illustrates the LCD shown in FIG. 7 taken along the VIII-VIII line.

Referring to FIGS. 5 to 8, an LCD according to an exemplary embodiment of the present invention includes a TFT array panel 100, a common electrode panel 200 facing the TFT array panel 100, and a liquid crystal layer 3 interposed between the panels 100 and 200.

The TFT array panel 100 will be described with reference to FIGS. 5, 7, and 8.

A plurality of gate conductors including a plurality of gate lines 121 and a plurality of storage electrode lines 131 are formed on an insulating substrate 110 made of a material such as transparent glass or plastic.

The gate lines 121 transmit gate signals and extend substantially in a transverse direction. Each of the gate lines 121 includes a plurality of gate electrodes 124 projecting upward, and an end portion 129 having an area contacting with another layer or an external driving circuit.

When the gate driver 400 is integrated in the substrate 110, the gate lines 121 may extend to be connected to the gate driver 400.

The storage electrodes 131 are supplied with a predetermined voltage such as the common voltage Vcom, and extend substantially parallel to the gate lines 121. Each of the storage electrode lines 131 is disposed between two adjacent gate lines 121 and nearly are equidistant from the two gate lines 121. Each of the storage electrode lines 131 includes a plurality of storage electrodes 137 extending upward and downward. The storage electrode lines 131 and the storage electrodes 137 may have various shapes and arrangements, and are not limited to those illustrated in FIG. 5.

The gate conductors 121 and 131 may be made of Al, Ag, Cu, Mo, Cr, Ta, Ti, or alloys thereof. However, they may have a multi-layered structure including two conductive films (not shown) having different physical characteristics. One of the two films may be made of a low resistive metal such as Al, Ag, Cu, or alloys thereof for reducing signal delay or voltage drop. The other film may be made of a material such as a Mo, Cr, Ta, Ti, or alloys thereof which have good physical, chemical, and electrical contact characteristics with other materials such as indium tin oxide (ITO) or indium zinc oxide (IZO). Examples of the combination of the two films are a lower Cr film and an upper Al alloy film and a lower Al alloy film and an upper Mo alloy film. However, the gate conductors 121 and 131 may be made of various metals or conductors.

The lateral sides of the gate conductors 121 and 131 are inclined relative to a surface of the substrate 110, and the inclination angles thereof range from about 30 to 80 degrees.

A gate insulating layer 140 preferably made of silicon nitride (SiNx) or silicon oxide (SiOx) is formed on the gate conductors 121 and 131.

A plurality of semiconductor islands 154, 156, and 157 preferably made of hydrogenated amorphous silicon (“a-Si”) or polysilicon are formed on the gate insulating layer 140. The semiconductor islands 154 are disposed on the gate electrodes 124.

A plurality of ohmic contact islands 163 and 165 are formed on the semiconductor islands 154, respectively, and a plurality of ohmic contact islands 166 and 167 are formed on the semiconductor islands 156 and 157, respectively.

The ohmic contacts 166, 165, 166, and 167 may be made of n+ hydrogenated a-Si heavily doped with an n-type impurity such as phosphorous, or they may be made of silicide.

The lateral sides of the semiconductor islands 154, 156, and 157 and the ohmic contacts 163, 165, 166, and 167 are inclined relative to the surface of the substrate 110, and the inclination angles thereof may be in a range of about 30 to 80 degrees.

A plurality of data conductors including a plurality of data lines 171 and a plurality of drain electrodes 175 are formed on the ohmic contacts 162, 165, 166, and 167 and the gate insulating layer 140.

The data lines 171 transmit data signals and extend substantially in a longitudinal direction to intersect the gate lines 121 and the storage electrode lines 131. Each of the data lines 171 includes a plurality of curved portions projecting to the right, and each of the curved portions includes a pair of oblique portions that are connected to each other to form a chevron and make an angle of about 45 degrees with the gate lines 121.

Each of the data lines 171 includes a plurality of source electrodes 173 projecting toward the gate electrodes 124 and an end portion 179 having an area contacting with another layer or an external driving circuit. The data lines 171 may extend to be connected to a data driver 500 that may be integrated in the substrate 110.

The drain electrodes 175 are separated from the data lines 171, disposed opposite the source electrodes 173 with respect to the gate electrodes 124, and include curved portions 176 and expansions 177. One end portion of each of the curved portions 176 is partly enclosed by a source electrode 173 and another end portion thereof is connected to an expansion 177. The curved portions 176 include a pair of oblique portions that are connected to each other to form a chevron and make an angle of about 45 degrees with the gate lines 121. The expansions 177 are connected to the curved portions 176, and overlap the storage electrodes 137.

A gate electrode 124, a source electrode 173, and a drain electrode 175 along with a semiconductor island 154 form a TFT having a channel formed in the semiconductor island 154 disposed between the source electrode 173 and the drain electrode 175.

The data conductors 171 and 175 may be made of a refractory metal such as Cr, Mo, Ta, Ti, or alloys thereof. However, they may have a multilayered structure including a refractory metal film (not shown) and a low resistive film (not shown). Examples of the multi-layered structure are a double-layered structure including a lower Cr/Mo alloy film and an upper Al alloy film, and a triple-layered structure of a lower Mo alloy film, an intermediate Al alloy film, and an upper Mo alloy film. However, the data conductors 171 and the drain electrodes 175 may be made of various metals or conductors.

The data conductors 171 and 175 have inclined edge profiles, and the inclination angles thereof range from about 30 to 80 degrees.

The ohmic contacts 163, 165, 166, and 167 are interposed only between the underlying semiconductor islands 155, 156, and 157 and the overlying conductors 171 and 175 thereon, and reduce the contact resistance therebetween. The semiconductor islands 154, 156, and 157 include some exposed portions, which are not covered by the data lines 171 and the drain electrodes 175, such as portions located between the source electrodes 173 and the drain electrodes 175. The semiconductor islands 156 and 157 are disposed on intersecting portions of each of the gate lines 121 and each of the storage electrode lines 131, and each of the data lines 171, to smooth the profile of the surface, thereby preventing disconnection of the data lines 171.

A passivation layer 180 is formed on the data conductors 171 and 175, and on the exposed semiconductor islands 154, 156, and 157. The passivation layer 180 is may be made of an inorganic or organic insulator. The organic insulator may have photosensitivity and a dielectric constant less than about 4.0. The passivation layer 180 may include a lower film of an inorganic insulator and an upper film of an organic insulator, such that it takes the excellent insulating characteristics of the organic insulator while preventing the exposed portions of the semiconductor islands 154 from being damaged by the organic insulator.

The passivation layer 180 has a plurality of contact holes 182 and 185 exposing the end portions 179 of the data lines 171 and the expansions 177 of the drain electrodes 175, respectively. The passivation layer 180 and the gate insulating layer 140 have a plurality of contact holes 181 exposing the end portions 129 of the gate lines 121.

A plurality of pixel electrodes 191 and a plurality of contact assistants 81 and 82 are formed on the passivation layer 180. They are preferably made of a transparent conductor such as ITO or IZO, or a reflective conductor such as Ag, Al, Cr, or alloys thereof.

Each of the pixel electrodes 191 includes first and second electrode portions 191a and 191b and a connection attaching the two electrode portions 191a and 191b to each other. Each electrode portion 191a or 191b includes cutouts 91-93.

The shapes and the arrangements of the pixel electrodes 191 are described above with reference to FIG. 4, and there further descriptions thereof are omitted.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of the common electrode panel 200 supplied with the common voltage Vcom. The electric fields determine the orientations of liquid crystal molecules (not shown) of the liquid crystal layer 3 disposed between the two electrodes 191 and 270.

When a voltage difference is generated between two terminals of the LC capacitor C_{LC}, a primary electric field substantially perpendicular to the surfaces of the panels 100 and 200 is generated in the LC layer 3. Both the pixel electrodes 191 and the common electrode 270 are commonly referred to as field generating electrodes. The LC molecules in the LC capacitor C_{LC} tend to change their orientations in response to the electric field so that their long axes may be perpendicular to the field direction. The molecular orientations determine the polarization of light passing through the LC layer 3.

A polarizer converts light polarization into light transmittance such that the pixels PX display the luminance represented by an image signal DAT.

A pixel electrode 191 and the common electrode 270 form a capacitor referred to as a “liquid crystal capacitor,” which stores applied voltages after the TFT turns off.

The tilt direction of the LC molecules is firstly determined by a horizontal field component. The horizontal field component is generated by the cutouts 71-73 and 91-93 of the field generating electrodes 191 and 270 and the edges of the electrode portions 191a and 191b which distort the primary electric field. The horizontal field component is substantially perpendicular to the edges of the cutouts 71-79 and 91-93, and the edges of the electrode portions 191a and 191b.

Referring to FIGS. 4 and 7, since the LC molecules on each of the sub-areas divided by a set of the cutouts 71-73 and 91-93 tilt perpendicular to the major edges of the sub-area, the azimuthal distribution of the tilt directions are localized to four directions, thereby increasing the reference viewing angle of the LCD.

The direction of a secondary electric field due to a voltage difference between adjacent electrode portions 191a and 191b is perpendicular to the major edges of the sub-areas. Accordingly, the field direction of the secondary electric field coincides with that of the horizontal component of the primary electric field. Consequently, the secondary electric field between the adjacent electrode portions 191a and 191b enhances the determination of the tilt directions of the LC molecules.

An expansion 177 of a drain electrode 175 connected to a pixel electrode 191 overlaps a storage electrode 137 across the gate insulating layer 140, to form an additional capacitor referred to as a “storage capacitor,” which enhances the voltage storing capacity of the liquid crystal capacitor C_{LC}.

The data lines 171, in particular the curved portions of the data lines 171, extend along some of the curved edges of the pixel electrodes 191 to be curved. Therefore, the electric field generated between the data lines 171 and the electrode portions 191a and 191b has a horizontal component that is substantially parallel to the horizontal component of the primary electric field such that the determination of the tilt direction of the LC molecules is enhanced. In addition, the aperture ratio is increased.

The storage electrode lines 131, the expansions 177 of the drain electrodes 175, and the contact holes 185 are disposed under and over the connections of the pixel electrodes 191.

The connections form boundaries of the above-described sub-areas, and thus this configuration can cover a texture that may be generated by the disorder of the LC molecules near the boundaries of the sub-areas, thereby improving the aperture ratio.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

A description of the common electrode panel 200 follows with reference to FIGS. 6 to 8.

A light blocking member 220 referred to as a black matrix for preventing light leakage is formed on an insulating substrate 210 made of a material such as transparent glass or plastic.

The light blocking member 220 includes a pair of transverse portions facing the gate lines 121 and the storage electrode lines 131 on the lower panel 100, curved portions facing the curved edges of the pixel electrodes 191 on the lower panel 100, and widened portions facing the TFTs Q on the lower panel 100.

A plurality of color filters 230 are also formed on the substrate 210 and the light blocking member 220. The color filters 230 are disposed substantially in areas enclosed by the light blocking member 220. The color filters 230 may extend substantially in a longitudinal direction along the pixel electrodes 191. The color filters 230 may represent one of the primary colors such as red, green, and blue.

An overcoat 250 is formed on the color filters 230 and the light blocking member 220. The overcoat 250 is preferably made of an (organic) insulator, and it prevents the color filters 230 from being exposed and provides a flat surface. The overcoat 250 is optional.

A common electrode 270 is formed on the overcoat 250. The common electrode 270 may be made of a transparent conductive material such as ITO and IZO, and has a plurality of sets of cutouts 71, 72, and 73.

Each of the cutouts 71-73 has at least one oblique portion having a depressed notch of a triangular shape. The notch may have various shapes such as a rectangle, a trapezoid, or a semicircle, and may be convexly or concavely formed.

The notches in the cutouts 71-73 determine the tilt directions of the LC molecules 3 on the cutouts 71-73.

The number of cutouts 71-73 and 91-93 may be varied depending on design factors, and the light blocking member 220 may also overlap the cutouts 71-73 and 91-93 to block light leakage through the cutouts 71-73 and 91-93.

Alignment layers 11 and 21 are formed on inner surfaces of the panels 100 and 200, and may be vertical alignment layers.

Polarizers 12 and 22 are provided on outer surfaces of the panels 100 and 200 so that their polarization axes may be crossed, and one of the polarization axes may be parallel to the gate lines 121. One of the polarizers 12 and 22 may be omitted when the LCD is a reflective LCD.

The LCD may further include at least one retardation film (not shown) for compensating the retardation of the LC layer 3. The LCD may further include a backlight unit (not shown) for supplying light to the LC layer 3 and the panels 100 and 200.

The LC layer 3 may have a negative dielectric anisotropy and be subjected to a vertical alignment in which the LC molecules in the LC layer 3 are aligned such that their long axes are substantially vertical to the surfaces of the panels 100 and 200 in the absence of an electric field.

At least one of the cutouts 71-73 and 91-93 can be substituted with protrusions (not shown) or depressions (not shown). The protrusions may be made of an organic or inorganic material and are disposed on or under the field generating electrodes 191 or 270.

Referring to FIG. 1, the gray voltage generator 800 generates two sets of a plurality of gray voltages (or reference gray voltages) related to the transmittance of the pixels PX. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines of the panel assembly 300, and applies data voltages that are selected from the gray voltages supplied from the gray voltage generator 800 to the data lines D₁-Dₘ. However, the data driver 500 may generate gray voltages for all the grays by dividing the reference gray voltages and selecting the data voltages from the generated gray voltages when the gray voltage generator 800 generates reference gray voltages.

Each of the processing units 400, 500, 600, and 800 may include at least one integrated circuit (IC) chip mounted on the LC panel assembly 300 or on a flexible printed circuit (FPC) film as a tape carrier package (TCP) type, which are attached to the LC panel assembly 300. Alternately, at least one of the processing units 400, 500, 600, and 800 may be integrated with the LC panel assembly 300 along with the signal lines and the switching elements Q. As a further alternative, all the processing units 400, 500, 600, and 800 may be integrated into a single IC chip, but at least one of the processing units 400, 500, 600, and 800 or at least one circuit element of at least one of the processing units 400, 500, 600, and 800 may be disposed outside of the single IC chip.

The signal controller 600 controls the gate driver 400 and the data driver 500. The signal controller 600 is supplied with input image signals R, G, and B and input control signals for controlling the display thereof from an external graphics controller (not shown). The input image signals R, G, and B contain luminance information of each pixel PX, and the luminance has a predetermined number of grays, for example, 1024 (=2¹⁰), 256 (=2⁸), or 64 (=2⁶). The input control signals include a vertical synchronization signal Vsync, a horizontal synchronization signal Hsync, a main clock signal MCLK, a data enable signal DE, etc.

After generating gate control signals CONT1 and data control signals CONT2 and processing the image signals R, G, and B to be suitable for the operation of the LC panel assembly 300 on the basis of the input control signals and the input image signals R, G, and B, the signal controller 600 transmits the gate control signals CONT1 to the gate driver 400 and the processed image signals DAT and the data control signals CONT2 to the data driver 500. The output image signals DAT are digital signals and have values (or grays) of the predetermined number.

The gate control signals CONT1 include a scanning start signal STV for instructing scanning to start and at least one clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for indicating a start of data transmission for a group of pixels PX, a load signal LOAD for instructing application of the data voltages to the data lines D₁-Dₘ, and a data clock signal HCLK. The data control signal CONT2 may further include an inversion signal RVS for reversing the polarity of the data voltages with respect to the common voltage Vcom.

Responsive to the data control signals CONT2 from the signal controller 600, the data driver 500 receives a packet of the image data DAT for the group of pixels PX from the signal controller 600 and receives the gray voltages supplied from the gray voltage generator 800. The data driver 500 converts the image data DAT into analog data voltages selected from the gray voltages supplied from the gray voltage generator 800, and applies the data voltages to the data lines D₁-Dₘ.

The gate driver 400 applies the gate-on voltage Von to the gate lines G₁-Gₙ in response to the gate control signals CONT1 from the signal controller 600, thereby turning on the switching elements Q connected thereto. The data voltages applied to the data lines D₁-Dₘ are supplied to the pixels PX through the activated switching elements Q.

A difference between a data voltage and a common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. A polarizer converts the light polarization into the light transmittance such that the pixels PX display the luminance represented by the gray of the image data DAT.

By repeating this procedure by a unit of a horizontal period (which is denoted by “1H” which is equal to one period of the horizontal synchronization signal Hsync and the data enable signal DE), all gate lines G₁-Gₙ are sequentially supplied with the gate-on voltage Von during a frame, thereby applying data voltages to all pixels PX.

When a next frame starts after one frame finishes, the inversion control signal RVS applied to the data driver 500 is adjusted such that the polarity of the data voltages is reversed (which is referred to as “frame inversion”). The inversion control signal RVS may also be controlled such that the polarity of the data voltages flowing in a data line in one frame is reversed during one frame (for example, line inversion and dot inversion), or the polarity of the data voltages in one packet is reversed (for example, column inversion and dot inversion).

The voltage across the LC capacitor C_{LC} forces the LC molecules in the LC layer 3 to be reoriented into a stable state corresponding to the voltage, and the reorientation of the LC molecules takes time since the response time of the LC molecules is slow. The LC molecules continue to reorient themselves to vary the light transmittance until they reach the stable state as long as the voltage is maintained across the LC capacitor C_{LC}. When the LC molecules reach the stable state and stop the reorientation, the light transmittance becomes fixed.

A pixel voltage in the stable state is referred to as a “target pixel voltage” and a light transmittance in the stable state is referred to as “target light transmittance”. When the target pixel voltage and the target light transmittance are both in the stable state they have a one-to-one correspondence.

Since a period of time for turning on the switching element Q of each pixel PX to apply a data voltage to the pixel is limited, it is difficult for the LC molecules in the pixel PX to reach the stable state during the application of the data voltage. However, even though the switching element Q is turned off, the voltage across the LC capacitor C_{LC} is still present and the LC molecules continue the reorientation such that the capacitance of the LC capacitor C_{LC} changes. Ignoring leakage current, the total amount of electrical charges stored in the LC capacitor C_{LC} is kept constant when the switching element Q turns off since one terminal of the LC capacitor C_{LC} is floating. Variation of the capacitance of the LC capacitor C_{LC} results in variation of the voltage across the LC capacitor C_{LC}, i.e., the pixel voltage.

Consequently, when a pixel PX is supplied with a data voltage corresponding to a target pixel voltage (referred to as a “target data voltage” hereinafter), which is determined in the stable state, an actual pixel voltage of the pixel PX may be different from the target pixel voltage such that the pixel PX may not reach a corresponding target light transmittance. The actual pixel voltage differs more from the target pixel voltage as the target transmittance differs more from an initial light transmittance of the pixel PX. differs more from the target pixel voltage as the target transmittance differs more from an initial light transmittance of the pixel PX.

Accordingly, a data voltage applied to the pixel PX is required to be higher or lower than a target data voltage, and for example, this can be realized by dynamic capacitance compensation (DCC).

According to an exemplary embodiment of the present invention, DCC, which may be performed by the signal controller 600 or a separate image signal modifier, modifies an image signal of a frame (referred to as a “current image signal” hereinafter) g_{N} for a pixel to generate a modified current image signal (referred to as a “first modified image signal” hereinafter) g_{N}′ based on an image signal of an immediately previous frame (referred to as a “previous image signal” hereinafter) g_{N-1} for the pixel. The first modified image signal g_{N}′ is generally obtained by experimentation, and the difference between the first modified current image signal g_{N}′ and the previous image signal g_{N-1}′ is usually larger than the difference between the current image signal g_{N} before modification and the previous image signal g_{N-1}′. However, when the current image signal g_{N}′ and the previous image signal g_{N-1}′ are equal to each other or the difference therebetween is small, the first modified image signal g_{N}′ may be equal to the current image signal g_{N}.

The first modified image signal g_{N}′ may be represented as a function F1 of Equation 1.
g_{N}′=F1(g_{N},g_{N-1}) [Equation 1]

Accordingly, the data voltage applied from the data driver 500 to each pixel PX is larger or smaller than the target data voltage.

TABLE 1 shows exemplary modified image signals for some pairs of previous image signals g_{N-1} and current image signals g_{N} in a 256 gray system.

TABLE 1

| | | g_{N-1} | | | | | | | | |
|---|---|---|---|---|---|---|---|---|---|---|
| | | 0 | 32 | 64 | 96 | 128 | 160 | 192 | 224 | 255 |
| g_{N} | 0 | 0 | 0 | 0 | 0 | 0 | 0 | 0 | 0 | 0 |
| | 32 | 115 | 32 | 22 | 20 | 15 | 15 | 15 | 15 | 15 |
| | 64 | 169 | 103 | 64 | 50 | 34 | 27 | 22 | 20 | 16 |
| | 96 | 192 | 146 | 118 | 96 | 87 | 70 | 54 | 36 | 29 |
| | 128 | 213 | 167 | 156 | 143 | 128 | 121 | 105 | 91 | 70 |
| | 160 | 230 | 197 | 184 | 179 | 174 | 160 | 157 | 147 | 129 |
| | 192 | 238 | 221 | 214 | 211 | 205 | 199 | 192 | 187 | 182 |
| | 224 | 250 | 245 | 241 | 240 | 238 | 238 | 224 | 224 | 222 |
| | 255 | 255 | 255 | 255 | 255 | 255 | 255 | 255 | 255 | 255 |

This image signal modification requires storage such as a frame memory for storing the previous image signals g_{N-1} and a lookup table for storing relationships that may be those shown in TABLE 1.

Since the size of a lookup table containing the first modified image signals g_{N}′ for all pairs of current and previous image signals g_{N-1} and g_{N} may be quite large, by using a process of interpolation, a smaller number of pairs can be used. For example, the first modified image signals g_{N}′ for some pairs of previous and current image signals g_{N-1} and g_{N} like those shown in TABLE 1 may be stored as reference modified signals and the first modified image signals g_{N}′ for remaining pairs of previous and current image signals g_{N-1} and g_{N} can be obtained by interpolation. The interpolation of a pair of previous and current image signals g_{N-1} and g_{N} is accomplished by finding the first modified image signals g_{N}′ for pairs of previous and current image signals g_{N-1} and g_{N} close to a signal pair in TABLE 1 and calculating the first modified signal g_{N}′ for the signal pair based on the found reference modified signals.

For example, each image signal that is a digital signal is divided into most significant bits (MSBs) and least significant bits (LSBs), and the lookup table stores reference modified signals for the pairs of previous and current image signals g_{N-1} and g_{N} having zero LSBs. For a pair of previous and current image signals g_{N-1} and g_{N}, some reference modified image signals associated with a MSB of the signal pair are found, and a first modified image signal g_{N}′ for the signal pair is calculated from the LSB of the signal pair and the reference modified image signals found from the lookup table.

However, the target transmittance may be obtained by another method. In this method, a predetermined voltage such as an intermediate voltage of the target data voltage of a pixel at the previous frame is pre-applied to the pixel to pre-tilt the LC molecules, and then the target data voltage is applied to the pixel at the present frame.

For this purpose, the signal controller 600 or an image signal modifier modifies a current image signal g_{N} in consideration of an image signal of the next frame (referred to as a “next image signal” hereinafter) as well as a previous image signal g_{N-1}, to generate a modified current image signal (referred to as a “second modified image signal) g_{N}”.

For example, if the next image signal is very different from the current image signal g_{N} even though the current image signal g_{N} is equal to the previous image signal g_{N-1}, the current image signal g_{N} is modified to prepare the next frame.

The second modified image signal g_{N}″ may be represented as a function F2 described in Equation 2. A frame memory is required for storing the previous image signal g_{N-1} and the current image signal g_{N} and a lookup table is necessary for storing the modified image signals with respect to pairs of the previous and current image signals g_{N-1} and g_{N}.

Alternatively, a lookup table may be further required for storing the modified image signals with respect to pairs of the current and next image signals gN and gN+1.
gN″=F2(gN′,gN+1) [Equation 2]

The modification of the image signals and the data voltages may or may not be performed for the highest gray or the lowest gray. In order to modify the highest gray or the lowest gray, the range of the gray voltages generated by the target data voltages required for obtaining the range of the target luminance (or the target transmittance) represented by the grays of the image signals.

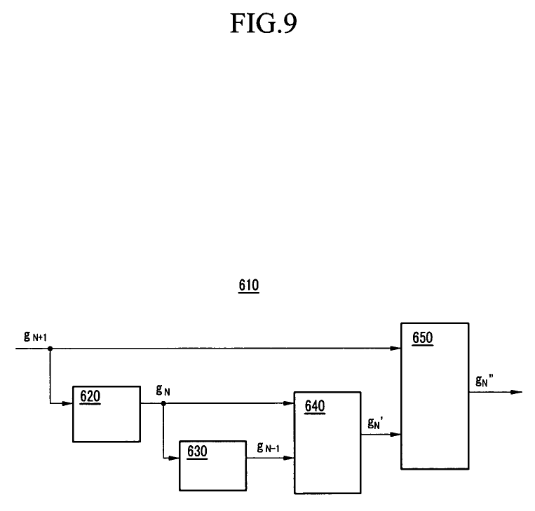

An image signal modifier of an LCD according to an exemplary embodiment of the present invention will be described with reference to FIGS. 9 to 11.

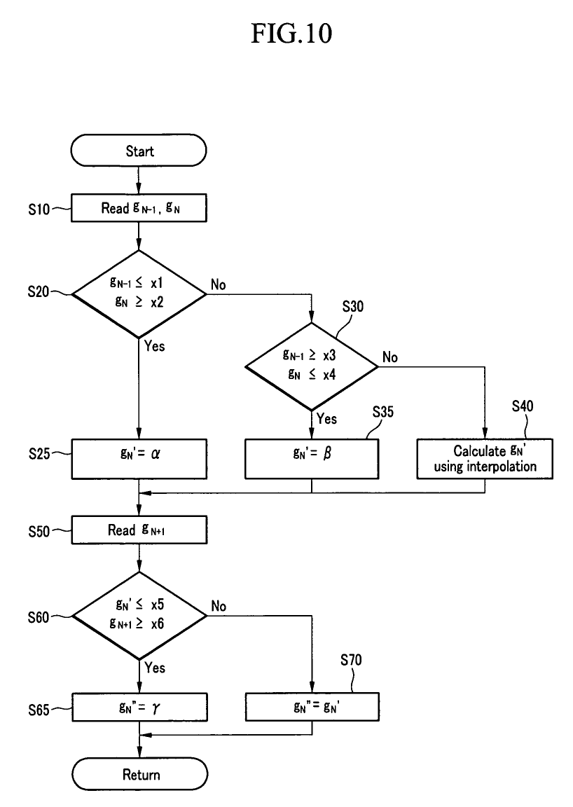

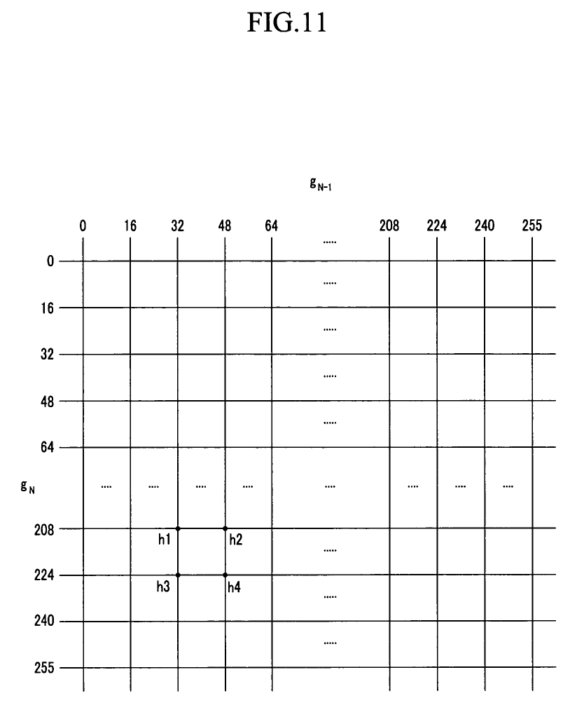

FIG. 9 is a block diagram of an image signal modifier of an LCD according to an exemplary embodiment of the present invention, FIG. 10 is a flow chart indicating the operations of the image signal modifier shown in FIG. 9, and FIG. 11 is a schematic diagram for explaining an image signal modifying method according to an exemplary embodiment of the present invention.

As shown in FIG. 9, an image signal modifier 610 includes a first memory 620, a second memory 630 connected to the first memory 620, a first modifier 640 connected to the first and second memories 620 and 630, and a second modifier 650 connected to the first modifier 640. At least one circuit element of the image signal modifier 610 may be included in the signal controller 600 of FIG. 1, or may be implemented as a separate apparatus.

The first memory 620 transmits a current image signal g_{N} to the second memory 630 and the first modifier 640, and receives a next image signal g_{N+1} to store as a current image signal of the next frame.

The second memory 630 transmits a stored previous image signal g_{N-1} therein to the first modifier 640, and receives the current image signal g_{N} from the first memory 620 to store as the previous image signal of the next frame.

Here, the first memory 620 is separated from the second memory 630, but one memory may store the previous and current image signals g_{N-1} and g_{N}, apply them to the first modifier 640, and receive the next image signal g_{N+1} for storing.

The first modifier 640 includes a lookup table (not shown) and calculates a first modified image signal g_{N}′ based on the previous and current image signals g_{N-1} and g_{N} from the second and first memories 630 and 620, to output to the second modifier 650.

The second modifier 650 calculates the second modified signal g_{N}″ for output based on the next image signal g_{N+1} and the first modified image signal g_{N}′ from the first modifier 640.

Referring to FIG. 10, when the operations start, the first modifier 640 reads a current image signal g_{N} and a previous image signal g_{N-1} from the first and the second memories 620 and 630, respectively (S10).

Then, the first modifier 640 compares a value of the previous image signal g_{N-1} and a predetermined value x1, and compares a value of the current image signal g_{N} and a predetermined value x2 (S20).

When the value of the previous image signal g_{N-1} is less than the predetermined value x1, and the value of the current image signal g_{N} is more than the predetermined value x2, a value of the first modified image signal g_{N}′ is defined as a modification value α (S25). However, when the conditions of step s20 are not met, the first modifier next compares a value of the previous image signal g_{N-1} and a predetermined value x3, and compares a value of the current image signal g_{N} and a predetermined value X4 (S30). If the previous image signal g_{N-1} is greater than the predetermined value x3, and the current image signal g_{N} is less than the predetermined value x4, the value of the first modified image signal g_{N}′ is defined as a modification value β (S35).

Here, the predetermined value x1 is an upper limit threshold value of the previous image signal g_{N-1} for an overshoot voltage, and the predetermined value x2 is a lower limit threshold voltage of the current image signal g_{N} for the overshoot voltage.

The predetermined value x3 is a lower limit threshold value of the previous image signal g_{N-1} for an undershoot voltage, and the predetermined value x4 is an upper limit threshold voltage of the current image signal g_{N} for the undershoot voltage.

The modification values α and β are upper and lower limits of the image signal, respectively, for example, when the image signal has 8-bits, the modification values α and β are “255” and “0”, respectively.

It is assumed that the image signal has 8 bits, hereinafter.

The modification value “255” corresponds to a voltage higher than a maximum target data voltage (hereinafter, referred to as an “overshoot voltage”), and the modification value “0” corresponds to a voltage lower than a minimum target data voltage (hereinafter, referred to as an “undershoot voltage”). The overshoot and undershoot voltages are upper and lower limits, respectively, which the gray voltage generator 800 generates.

For applying the overshoot and undershoot voltages, the signal controller 600 reduces a range of the input image signal through color compensation for coinciding color quality every gray of three primary colors.

That is, the input image signal normally has a range of value of 0 to 255, but through the color compensation has an adjusted range of values of 1 to 254.

The adjusted value “1” corresponds to the minimum target data voltage, and the adjusted value “254” corresponds to the maximum target data voltage. When the LCD is in a normal black mode, the adjusted value “1” corresponds to a black gray, and the adjusted value “254” corresponds to a white gray.

Next, it is assumed that the LCD is in the normal black mode.

Application of the overshoot voltage is not always necessary. When the overshoot voltage is not applied, the modification value “255” corresponds to the maximum target data voltage, and thereby is the white gray. Moreover, the range of the input image signal is not adjusted, thereby being 1 to 255.

However, when conditions of steps S20 and S30 are not satisfied, the first modifier 640 reads a plurality of reference modified image signals from a lookup table, which correspond to the pair of the input previous and current image signals g_{N-1} and g_{N}, and then calculates the first modified image signal g_{N}′ using interpolation, along with the previous image signal g_{N-1} and the current image signal g_{N} (S40).

Referring to FIG. 11, the reference modified image signals with respect to pairs of the previous and current image signals g_{N-1} and g_{N}, of which the number is 17×17 separated by a unit of 16 grays, are stored in the lookup table. When a pair of the previous and current image signals g_{N-1} and g_{N} is (36, 218), the first modifier 640 extracts the reference modified image signals h1, h2, h3, and h4 with respect to each of the pairs of the previous and current image signals [(32, 208), (48, 208), (32, 224), (48, 224)] from the lookup table and linear-interpolates on the basis thereof to calculate the first modified image signal g_{N}′.

Referring to FIG. 10, the second modifier 650 reads a next image signal g_{N+1} (S50).

The second modifier 650 then compares the first modified image signal g_{N}′ from the first modifier 640 and a predetermined value x5, and compares the next image signal g_{N+1} and a predetermined value x6 (S60).

When the first modified image signal g_{N}′ is less than the predetermined value x5, and the next image signal g_{N+1} is more than the predetermined value x6, a value of a second modified image signal g_{N}″ is defined as the modification value γ (S65).

However, if the value of the first modified image signal g_{N} does not satisfy the conditions of step S65, the value of the second modified image signal g_{N}″ is equal to that of the first modified image signal g_{N}′ (S70).

After defining the value of the second modified image signal g_{N}″, the operations are returned.

Here, the modification value γ is larger than the value of the first modified image signal g_{N}′, and is provided for pre-tilting of the liquid crystals.

The predetermined value x5 is an upper threshold value of the first modified image signal g_{N}′, and the predetermined value x6 is a lower threshold value of the next image signal g_{N+1}, for the pre-tilting.

The predetermined values x1 to x6 and the modification value γ may vary based on the characteristics and design rules of the LCD and be determined through experimentation.

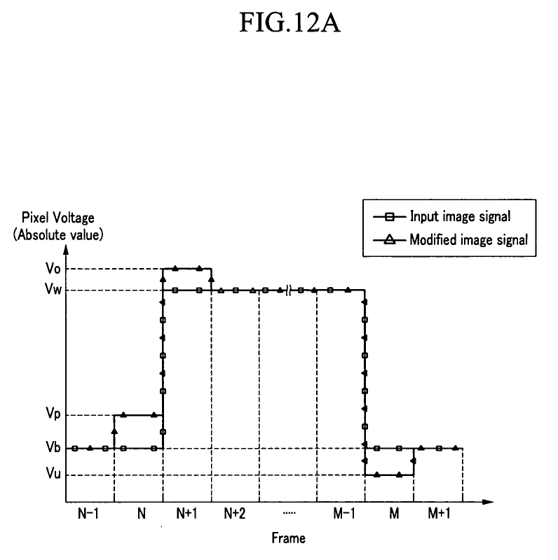

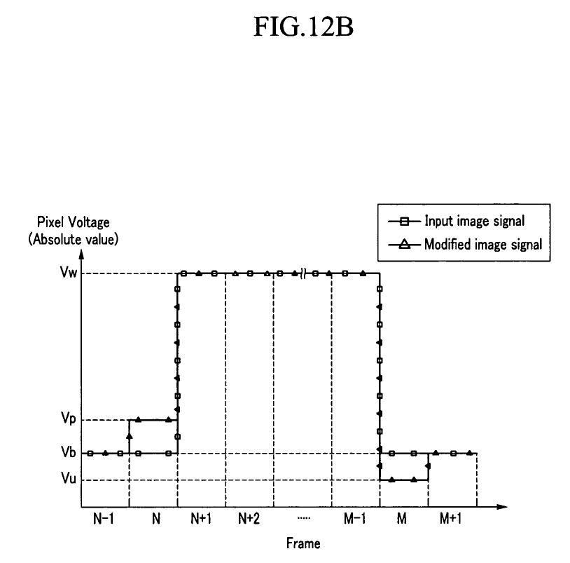

An operation for generating the second modified image signal with respect to the input image signal by the image signal modifier 610 according to an exemplary embodiment of the present invention will be described with reference to FIGS. 12A and 12B.

FIGS. 12A and 12B are waveform diagrams illustrating modified signals according to an exemplary embodiment of the present invention, respectively.

In the FIGS. 12A and 12B, the X axis represents a frame number, and the γ axis represents a pixel voltage expressed as an absolute value.

FIG. 12Aa is a waveform diagram showing a modified signal when the overshoot voltage is applied. The upper limit of the pixel voltage is the overshoot voltage Vo and the lower limit thereof is the undershoot voltage Vu.

However, FIG. 12B is a waveform diagram showing a modified signal when the overshoot voltage is not applied. Unlike FIG. 12A, the upper limit of the pixel voltage is the white voltage Vw.

Here, since the pixel voltage corresponds to an image signal being represented as a gray one-to-one for better comprehension and ease of description, the input image signal overlaps with the modified image signal. The respective pixel voltages corresponding to the black and white grays are assumed to be the black voltage Vb and white voltage Vw.

It is assumed that the input image signal has the black gray in (N−1)_th and N_th frames, the white gray in (N+1)_th and (N+2)_th frames, the white gray in the (M−1)_th frame, and the black gray in the M_th and (M+1)_th frames.

Referring to FIG. 12A, the first modifier 640 defines the first modified image signal in the (N+1)_th frame as the overshoot voltage Vo based on a difference between values of the input image signals in the N_th and (N+1)_th frames, and defines the first modified image signal in the M_th frame as the undershoot voltage Vu based on a difference between values of the input image signals in the (M−1) and M_th frames.

Then, input image signals in the N_th, (N+2)_th, and (M+1)_th frames are equal to those in the frames previous thereto, respectively, and thereby the first modified image signals in the N_th, (N+2)_th, and (M+1)_th frames are equal to the corresponding input image signals.

The second modifier 650 defines the second modified image signals in the N_th frame, which satisfies the conditions in step S60, as the modification value γ corresponding to the pre-tilt voltage Vp and causes the second modified image signals in the remaining frames to have values equal to those of the first modified image signals of the respective corresponding frames.

The final second modified image signals have the black voltage Vb, the pre-tilt voltage Vp, the overshoot voltage Vo, and the white voltage Vw in succession from the (N−1)_th frame, respectively. The final second modified image signals also have the white voltage Vw, the undershoot voltage Vu, and the black voltage Vb successively from the (M−1)_th frame, respectively.

When the second modified image signal is applied as the pre-tilt voltage Vp to the pixels in the N_th frame, the liquid crystals are pre-tilted to rapidly reach a target light transmittance for the white voltage Vw in the (N+1)_th frame.

Referring to FIG. 12B, the first and second modifiers 640 and 650 define the modified image signals modified in the (N+1)_th frame as the white voltage Vw, respectively. The operations of the first and second modifiers 640 and 650 in the remaining frames are the same as those of FIG. 12A. The maximum voltage of the gray voltages generated by the gray voltage generator 800 may be used as the white voltage Vw instead of the overshoot voltage Vo, and thereby luminance with respect to the white gray increases. Although the response time may decrease as compared to when the overshoot voltage is applied as in FIG. 12A, target response time may be satisfied by appropriately varying the pre-tilt voltage Vp.

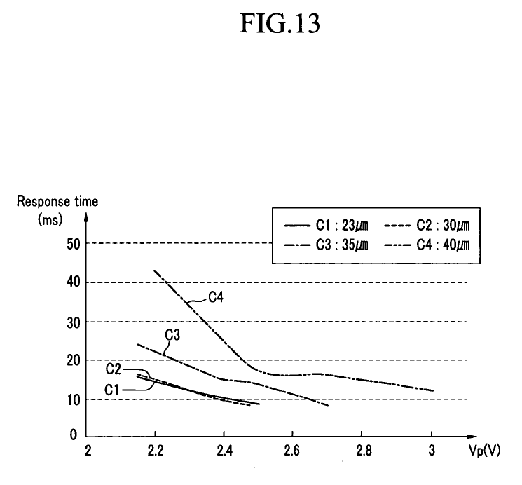

The relationship of the electrode intervals L1 and L2 of the LC panel assembly 300, the black voltage Vb, the pre-tilt voltage Vp, and the undershoot voltage (Vu) and the response time will be described in detail with reference FIGS. 13 to 16.

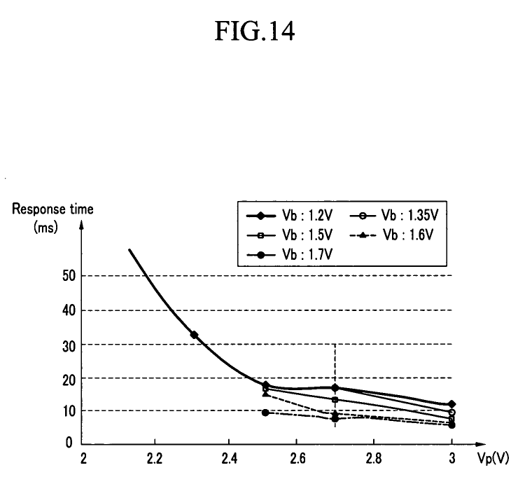

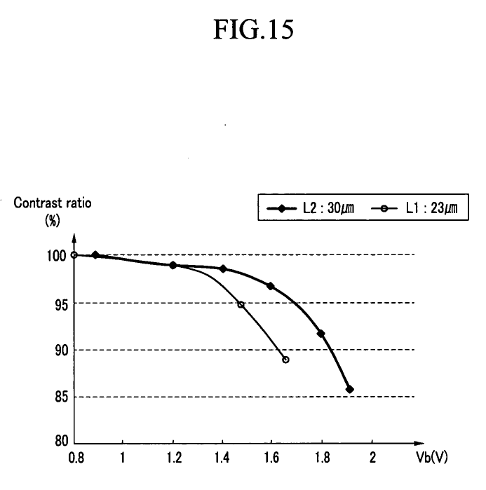

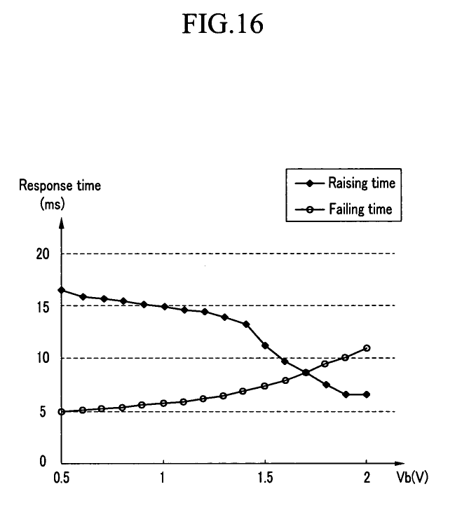

FIG. 13 is a graph illustrating response time with respect to electrode intervals and a pre-tilt voltage in an LCD according to an exemplary embodiment of the present invention, FIG. 14 is a graph illustrating response time with respect to a black voltage and a pre-tilt voltage in an LCD according to an exemplary embodiment of the present invention, FIG. 15 is a graph illustrating contrast ratio with respect to electrode intervals and a pre-tilt voltage in an LCD according to an exemplary embodiment of the present invention, and FIG. 16 is a graph illustrating response time with respect to a black voltage in an LCD according to an exemplary embodiment of the present invention.

In FIGS. 13 and 14, the X axis represents a pre-tilt voltage Vp and the γ axis represents rising time as response time.

The rising time is time when light transmittance goes from about 10% to about 90% of target light transmittance, which is when a gray of the input image signal is changed from the black gray into the white gray.

On the contrary, falling time is time when the light transmittance goes from about 90% to about 10% of the target light transmittance, which is when a gray of the input image signal is changed from the white gray to the black gray.

In FIG. 15, the X axis represents the black voltage Vb and the γ axis represents the contrast ratio.

In FIG. 16, the X axis represents the black voltage Vb and the γ axis represents the response time.

Referring to FIG. 13, the curve C1 illustrates a measurement of the rising time with respect to the pre-tilt voltage Vp after defining the electrode interval L1 as 23 microns as a shield of the sub-area SA2, and curves C2 to C3 illustrates a measurement of the rising time with respect to the pre-tilt voltage Vp after defining the electrode interval L1 as 30, 35, and 40 microns as shields of the sub-area SA2, respectively.

When the black voltage Vb was about 1.2V and the white voltage Vw was about 7.0V, an overshoot voltage Vo was applied.

The curves C1 and C2 almost coincide. That is, a difference in the response time depending on a difference between the electrode intervals L1 and L2 almost does not occur. Therefore, the sub-area SA2 having the electrode interval L2 of about 30 microns and the sub-area SA1 having the electrode interval L1 of about 23 microns have similar liquid crystal control power. When the pre-tilt voltage Vp is about 2.5V, the rising time is less than about 10 ms. However, like the curves C3 and C4, the response time becomes slow as the electrode interval L2 becomes larger and becomes fast as the pre-tilt voltage Vp becomes larger.

For increasing the transmittance, it is necessary to increase the width of the electrode interval.

As the size of the LCD becomes larger, the electrode interval becomes wider. For example, when a size of the LCD is 40 inches, an average electrode interval is about 42 microns. By increasing a magnitude of the pre-tilt voltage Vp as the electrode interval of the LCD becomes wider, the response time increases. However, a pre-tilt voltage Vp larger than a predetermined value may cause distortion of the light transmittance, decreasing image quality of motion images.

It is necessary to increase the response time without too much of an increment of the pre-tilt voltage Vp.

Referring to FIG. 14, each curve represents response time with respect to a varying magnitude of the black voltage Vb. The response time becomes faster as the magnitude of the black voltage Vb becomes larger, as shown in FIG. 14.

When the black voltage Vb is more than about 1.6V, the pre-tilt voltage Vp is about 2.7V, and the electrode interval is about 40 microns, the rising time is less than about 10 ms.

As the magnitude of the black voltage Vb becomes large, the liquid crystal control power increases to improve the response time, but the contrast ratio may decrease and the falling time may lengthen. Therefore, it is necessary to decrease the drop of the contrast ratio and to prevent delay of the falling time while using a large black voltage Vb.

Referring to FIG. 15, two curves represent the contrast ratio of the black voltage with respect to two electrode intervals, respectively. As shown in FIG. 15, as the electrode intervals become wider the drop in the contrast ratio decreases.

For example, when the electrode interval L1 is about 23 microns, the contrast ratio with respect to the black voltage Vb of about 1.6V is about 90% as compared with the contrast ratio with respect to the black voltage Vb of about 11V. However, in a case that the electrode interval L2 is about 30 microns, the contrast ratio is about 96%.

When the electrode interval L2 is wide, molecules of the liquid crystals near the center of the sub-area SA2 have little tilt even though the black voltage Vb is applied. Therefore, light leakage through the molecules decreases and the decrement of the contrast ratio decreases. When the electrode interval L2 becomes wide, space between the adjacent pixel electrodes decreases, thereby decreasing the light leakage and the decrement of the contrast ratio.

Referring to FIG. 16, variations of the rising time and the falling time with respect to the black voltage Vb are shown. As shown in FIG. 16, as the magnitude of the black voltage Vb increases, the rising time decreases and the falling time increases. Here, the falling time was measured without the application of the undershoot voltage Vu. When an undershoot voltage Vu of about 0.5V to 1.2V is applied and the black voltage Vb is about 1.5V to 2.0V, the falling time of about 6 ms was measured. As a result, although the magnitude of the black voltage Vb is large, the increment of the falling time is prevented by applying the undershoot voltage Vu.

When the electrode interval L1 is about 20 microns to 30 microns, the electrode interval L2 is more than about 30 microns, the white voltage Vw is about 7.0V, the black voltage Vb is about 1.5V to 2.0V, the pre-tilt voltage Vp is about 2.5V to 3.0V, and the undershoot voltage Vu is about 0.5V to 1.2V, the response time increases without deterioration of image quality.

The numerical values described above are only examples, and may be varied depending on characteristics of the LCD.

Image signal modification according to the present invention may also be applied when the pixel electrodes have a rectangular shape as well as to the liquid crystal panel assembly shown in FIGS. 3A to 8.

While this invention has been described in connection with exemplary embodiments thereof, it is to be understood that the invention is not limited to the disclosed exemplary embodiments, and is intended to cover various modifications and equivalent arrangements included within the spirit and scope of the appended claims.

What is claimed is:

1. A liquid crystal display comprising:
a plurality of pixels having a plurality of sub-areas;
an image signal modifier for generating a preliminary signal based on a previous image signal and a current image signal and generating a modified image signal based on the preliminary signal and a next image signal; and
a data driver for changing the modified image signal from the image signal modifier into a data voltage and supplying it to the pixels,
wherein a minimum target pixel voltage of difference voltages between the data voltage and a common voltage is larger than a minimum pixel voltage.

2. The liquid crystal display of claim 1, wherein the minimum target pixel voltage corresponds to a black gray and has a range of about 1.5V-2.0V.

3. The liquid crystal display of claim 1, wherein when the previous image signal is greater than a first predetermined value and the current image signal is less than a second predetermined value, the minimum pixel voltage is applied to the pixels.

4. The liquid crystal display of claim 3, wherein the minimum pixel voltage is about 0.5V-1.2V.

5. The liquid crystal display of claim 1, wherein a difference between the preliminary signal and the previous image signal is greater than that between the current image signal and the previous image signal.

6. The liquid crystal display of claim 5, wherein when the preliminary signal is less than a third predetermined value and the next image signal is more than a fourth predetermined value, a pre-tilt voltage is applied.

7. The liquid crystal display of claim 6, wherein the pre-tilt voltage is about 2.5V-3.0V.

8. The liquid crystal display of claim 1, wherein a maximum target pixel voltage corresponding to a white gray is less than the maximum pixel voltage.

9. The liquid crystal display of claim 1, wherein a maximum target pixel voltage corresponding to a white gray is substantially equal to the maximum pixel voltage.

10. The liquid crystal display of claim 1, wherein the sub-areas comprise a plurality of first sub-areas adjacent to neighboring pixels and a plurality of second sub-areas disposed between the first sub-areas.

11. The liquid crystal display of claim 10, wherein a width of each of the first sub-areas is greater than about 30 microns and a width of each of the second sub-areas is about 20-30 microns.

12. The liquid crystal display of claim 1, further comprising:
a plurality of tilt direction defining members for sectioning the sub-areas and for defining a tilt direction of liquid crystal molecules.

13. The display of claim 12, wherein each of the tilt direction defining members comprises at least one of a cutout, a protrusion, and a depression.

14. A liquid crystal display comprising:
a pixel electrode having a first electrode portion having a first pair of oblique edges parallel to and facing each other and a second electrode portion having a second pair of oblique edges parallel to and facing each other;
a common electrode facing the pixel electrode;
a liquid crystal layer interposed between the pixel electrode and the common electrode;
a first tilt direction defining member formed on the second electrode portion, having a first cutout including a first oblique portion substantially parallel to the second pair of oblique edges, for defining a tilt direction of liquid crystal molecules of the liquid crystal display; and
a second tilt direction defining member formed on the common electrode, having a second cutout including a second oblique portion substantially parallel to the second pair of oblique edges, for defining the tilt direction of the liquid crystal molecules of the liquid crystal display,
wherein a black voltage applied between the pixel electrode and the common electrode is about 1.5V-2.0V.

15. The liquid crystal display of claim 14, wherein a distance between the first oblique portion and the second oblique portion is about 20-30 microns, and a distance between the second pair of oblique edges and the second oblique portion is greater than about 30 microns.

16. A driving method of a liquid crystal display having a plurality of pixels, the method comprising:
reading a previous image signal, a current image signal, and a next image signal;
generating a preliminary signal based on the previous image signal and the current image signal;
generating a modified image signal based on the preliminary signal and the next image signal; and
applying a pixel voltage corresponding to the modified image signal to the pixels,
wherein a minimum target pixel voltage corresponding to a black gray is larger than a minimum pixel voltage.

17. The method of claim 16, wherein when the previous image signal is greater than a first predetermined value and the current image signal is less than a second predetermined value, the minimum pixel voltage is applied to the pixels.

18. The method of claim 16, wherein the preliminary signal is generated such that a difference between the preliminary signal and the previous image signal is greater than the difference between the current image signal and the previous image signal, and
when the preliminary signal is less than a third predetermined value and the next image signal is greater than a fourth predetermined value, a pre-tilt voltage is applied.

19. The method of claim 16, wherein a maximum target pixel voltage corresponding to a white gray is less than a maximum pixel voltage.

20. The method of claim 16, wherein a maximum target pixel voltage corresponding to a white gray is substantially equal to a maximum pixel voltage.
